(19) United States
(12) Patent Application Publication
(10) Pub. No.: US 2003/0211857 A1
(43) Pub. Date: Nov. 13, 2003

(54) Sequence number checking in communicating messages in a universal mobile telecommunications system (UMTS) network

(76) Inventors: David Afshartous, London (GB); Qiang Cao, Swindon (GB); Gordon Peter Young, Bracknell (GB)

Correspondence Address: Docket Administrator (Room 3J-219), Lucent Technologies Inc., 101 Crawfords Corner Road, Holmdel, NJ, 07733-3030, US

(21) Appl. No.: 10/430,136

(22) Filed: May 6, 2003

(30) Foreign Application Priority Data
May 8, 2002 (EP) 02253221.2

(51) Int. Cl. H04B 7/005; H04B 7/01

(52) U.S. Cl. 455/502; 455/561

(57) ABSTRACT

In a method of communicating messages between a transmitter and receiver, wherein each message is sent in sequence and includes a sequence number. An expected sequence number, which is stored in the receiver, is incremented upon receipt of a message. The received sequence number in the message is decoded and compared to the incremented expected sequence number. If the numbers match the message is further decoded.

### CROSS REFERENCE TO RELATED APPLICATION

This application claims priority of European Application No. 022531221.2 filed on May 8, 2002.

### TECHNICAL FIELD

The present invention relates to telecommunications, and more particularly to a method of communicating messages between a transmitter and receiver.

### BACKGROUND OF THE INVENTION

In a Universal Mobile Telecommunications System (“UMTS”) network, which includes user terminals communicating with a UMTS terrestrial radio access network UTRAN, security has two aspects. One is integrity protection, which is applied on signalling messages. The other is ciphering, which is applied to both signalling and user data. Integrity protection ensures that the received signalling message may not have been altered by an unauthorised third party, whereas ciphering function ensures that the message data contents are not disclosed to any authorised party.

As regards the integrity protection aspect, as that is specified for UMTS, both the user terminal (user equipment) UE and the UMTS terrestrial radio access network UTRAN perform a specific integrity algorithm in accordance with the Third Generation Partnership Project 3GPP standards, as described in particular 3GPP Technical Specification 33.102. This algorithm, which is a KASUMI based algorithm, is known as the Integrity Protection f9 Algorithm. Apart from the desired integrity checking, performing the f9 algorithm results in delay being introduced. Most received messages are subject to an integrity check using the f9 before further processing. Another consequence is high consumption of power needed to run the integrity checks. This has a significant impact on the limited battery life of a user terminal UE.

FIG. 1 shows the known 3GPP standards approach to downlink DL integrity checking by the user terminal UE—e.g., when the user terminal UE receives a signalling message from the UMTS terrestrial radio access network UTRAN. The following three parameters are used, as shown in FIG. 1:

UTRAN DL_SN: this is the UMTS terrestrial radio access network UTRAN downlink sequence number DL_SN added to the downlink message by the UTRAN network;

UE DL_SN: this is the user terminal downlink sequence number UE DL_SN variable stored in and used by the user terminal UE control activation of the protection algorithm, f9. This is taken from the received message (UTRAN DL_SN).

UE DL_HFN: this is the user terminal UE downlink hyperframe number DL_HFN stored in user terminal UE used together with the UTRAN downlink sequence number UTRAN DL_SN to produce a parameter known as the COUNT-I parameter required together with others as input into the f9 algorithm.

The COUNT-I parameter is an integrity sequence number. As shown in FIG. 2, COUNT-I is composed of two parts: a “short” sequence number and a “long” sequence. The “short” sequence number is the 4-bit radio resource control sequence number (RRC SN). The “long” sequence number is the 28-bit radio resource control hyper frame number (RRC HFN), which is incremented when the radio resource control sequence number RRC SN wraps around. For the downlink, the radio resource control sequence number RRC SN is the 4 bit number UTRAN DL_SN included in each message from the transmitter. Each new message has the UTRAN DL_SN sequence number incremented by 1 from the UTRAN DL_SN sequence number in the previous (in sequence) message.

As shown in FIG. 1, the value of this sequence number is compared to the value for the related parameter UE DL_SN stored in the receiver as part of the verification of the message, and if the received sequence number is equal to the stored sequence number the message is discarded, else, the integrity protection algorithm f9 is performed, in the following cases:

(1) Normal case, e.g., that case where COUNT-I is assumed correct, e.g., where received sequence number is one greater than the stored sequence number, e.g., UTRAN DL_SN=UE DL_SN+1,

(2) An abnormal case, where the received sequence number is more than one greater than the stored sequence number, e.g., UTRAN DL_SN>UE DL_SN+1,

(3) The case where the received sequence number is less than the stored sequence number, e.g., UTRAN DL_SN<UE DL_SN.

Only in case (1) and case (3), when UTRAN DL SN wraps around, does the message go on to be fully processed. In case (3), the stored hyperframe number UE DL_HFN is incremented, as shown in FIG. 1. However, in case (3) when wrap around does not occur an increase in hyperframe number UE DL_HFN will then still lead to failure of the integrity check using the f9 algorithm, and so to unnecessary processing, following which the stored UE DL_HFN may be decremented.

### SUMMARY OF THE INVENTION

The present invention provides a method of communicating messages between a transmitter and receiver in a Universal Mobile Telecommunications System UMTS network, each message being sent in sequence and including a sequence number, an expected sequence number stored in the receiver being incremented upon receipt of a message, the received sequence number in the message being decoded and compared to the incremented expected sequence number and if the numbers match the message may be further decoded. The present invention also provides a corresponding method of receiving messages at a receiver in a UMTS network, a corresponding UMTS network, and a corresponding UMTS receiver.

The present invention provides improvements over the known approach defined in the UMTS standard. The present invention in its advantageous embodiments avoids running the integrity check algorithm on known invalid messages. A simple mechanism may be provided to determine whether to proceed to performing an f9 integrity check of the message without unnecessary activation of the f9 check. Advantageous embodiments of the present invention advantageously provide that by increasing user terminal downlink sequence number UE DL_SN by 1 and perform a check for “wrap around” check, followed by a check if user terminal downlink sequence number UE DL_SN may be equal to UTRAN DL_SN, the f9 algorithm may be performed when user terminal UE COUNT-I may be correct (e.g., would match a UTRAN COUNT-I), hence avoiding unnecessary running of f9. Advantages of the embodiments of the invention include reducing processing requirements, hence reducing processing delay and coping with less processing power; saving power, hence prolonging user terminal UE battery life; and providing a simpler approach requiring less complicated testing.

In an embodiment of the present invention, upon receipt of a message, the expected sequence number may be incremented by plus one.

In another embodiment of the present invention, the stored sequence number may be such that after reaching a maximum value upon a further increment the stored sequence number may revert to or through zero, whereupon a stored secondary count may be incremented.

In yet another embodiment of the present invention, the stored sequence number may be 4 bits, increments are by plus one such that the next incremented sequence number after a 1111 value may be a 0000 value, and the stored secondary count may be up to 28 bits.

In another embodiment of the present invention, upon the numbers matching, a value may be determined of a COUNT-I parameter which depends upon the incremented stored sequence number, the COUNT-I parameter value being used in the so-called f9 integrity checking method.

In another embodiment of the present invention, the COUNT-I parameter value depends on the incremented stored sequence number and the secondary count.

The present invention also provides a method of receiving messages at a receiver, each message including a sequence number, an expected sequence number stored in the receiver being incremented upon receipt of a message, the received sequence number in the message being decoded and compared to the incremented expected sequence number and if the numbers match the message may be further decoded.

The present invention also provides a communications system operative with a plurality of user terminals, and comprising a base station operative to send each message to a user terminal in sequence, each message including a sequence number, an expected sequence number stored in the user terminal being incremented upon receipt of a message, in the user terminal the received sequence number in the message being decoded and compared to the incremented expected sequence number and if the numbers match the message may be further decoded.

The present invention also provides a communications system comprising a receiver operative to receive messages each including a sequence number, the receiver including a data store which stores a sequence number, the stored sequence number being incremented upon receipt of a message (to form the expected sequence number), the receiver comprising a decoder and a comparator, the decoder being operative to decode a received sequence number in the message, and the comparator being operative to compare the received sequence number to the incremented stored sequence number (expected sequence number) and if the numbers match the message may be further decoded. Advantageously, the receiver may be a user terminal.

### BRIEF DESCRIPTION OF THE DRAWINGS

The present invention will be better understood from reading the following description of non-limiting embodiments, with reference to the attached drawings, wherein below:

FIG. 1 is a flowchart illustration of a known integrity check procedure;

FIG. 2 shows the structure of the COUNT-I parameter; and

FIG. 3 is a diagrammatic illustration of an integrity check procedure according to the present invention.

It should be emphasized that the drawings of the instant application are not to scale but are merely schematic representations, and thus are not intended to portray the specific dimensions of the invention, which may be determined by skilled artisans through examination of the disclosure herein.

### DETAILED DESCRIPTION

It was realised that as the UMTS terrestrial radio access network UTRAN may be expected to increase the sequence number UTRAN DL_SN of successive new messages by 1, the user terminal UE on reception of a new message can increment its stored sequence number UE DL_SN by 1, and compare it with the sequence number value sent by the UMTS terrestrial radio access network UTRAN to determine whether they match. This ensures a received sequence number and stored hyperframe number are not used by the user terminal UE to construct a COUNT-I which would definitely lead to the f9 algorithm check indicating a failure. This ensures that should the f9 check fail, that failure might be due to the value of some other input parameter into the f9 check algorithm being invalid, rather than the value of COUNT-I.

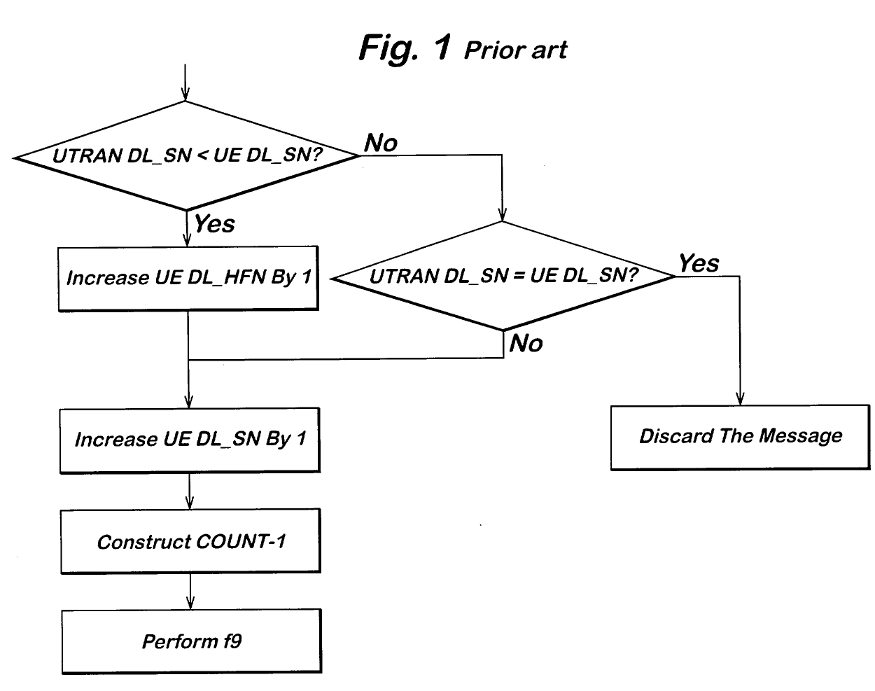

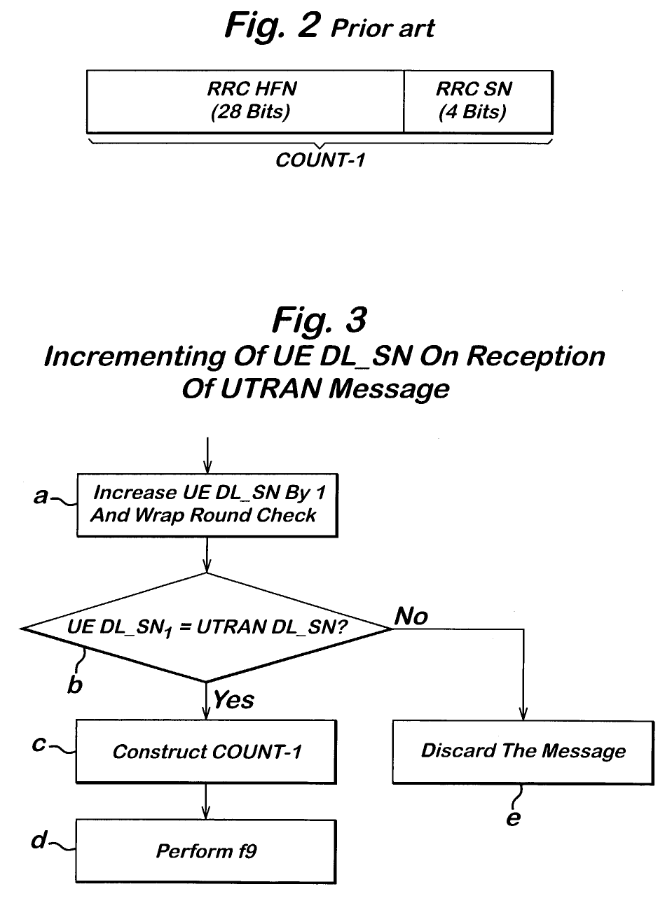

The variables shown in FIG. 3 as in FIG. 1 represent the following parameters: UTRAN DL_SN may be the sequence number added to the downlink message by the UMTS terrestrial radio access network UTRAN, UE DL_SN may be the sequence number variable stored in the user terminal UE (previously taken from the received message UTRAN DL_SN), and UE DL_HFN may be the variable stored in the user terminal UE and incremented when the UE DL_SN wraps around. The UE DL_HFN may be used with the UTRAN DL_SN as illustrated in FIG. 2, where the UE DL_HFN makes up the 28 MSB and the UTRAN DL_SN (generically referred to as the RRC SN) makes up the 4 LSB of the COUNT-I parameter to input into the f9 algorithm.

As shown in FIG. 3, upon receipt of a message, the user terminal's downlink sequence number UE DL_SN value may be now increased by 1, which we will refer to as UE DL_SN₁,and a wrap-around check performed (shown as step a in FIG. 3). The wrap-around check may be used to determine whether to increase the hyperframe number UE DL_HFN by 1 as well, which would be necessary to provide a correct COUNT-I value. The UTRAN downlink sequence number UTRAN DL_SN may be incremented by 1 in each new message, which may be sent from the transmitter (the UTRAN network). When incrementing the sequence number causes the four bit binary value ‘1111’ to become the binary value ‘0000’ it may be said to wrap around. To keep note of this at the user terminal in the context of determining COUNT-I when this wrap around occurs, the value of the hyperframe number UE DL_HFN stored in the user terminal needs to be incremented by 1.

This may be followed by determining whether newly incremented UE DL_SN₁ may be equal to UTRAN DL_SN (shown as step b in FIG. 3). If these two are equal the COUNT-I value may be produced (shown as step c in FIG. 3) and used in performing an f9 check (shown as step d in FIG. 3) and the UE DL_SN, may be stored in the UE as the UE DL_SN for the reception of the next UTRAN message.

This check ensures that whenever the received sequence number does not match that expected, e.g., UE DL_SN₁≠UTRAN DL_SN, the f9 check may be not run. Instead, the message may be discarded (shown as step e in FIG. 3). This includes the cases where the received sequence number may be greater than the UE expected sequence number, e.g., UTRAN DL _SN>UE DL_SN₁ or the received sequence number may be less than the UE expected sequence number, e.g., UTRAN DL _SN<UE DL_SN₁, the message may be discarded without the resource demanding f9 algorithm being executed.

This approach ensures that before performing the integrity check f9 algorithm, the UE COUNT-I may be correct, e.g., in line with the UTRAN COUNT-I, so integrity may be possible. Unnecessary running of the f9 integrity check algorithm may be thus avoided.

In an alternative embodiment, a corresponding approach may be used at the base station for communications on the uplink, e.g., from a user terminal to a base station of a network. In a further embodiment the approach is used at both ends (e.g., base station of the UTRAN, and user terminal) for incoming communications, e.g., for both uplink and downlink communications.

While the particular invention has been described with reference to illustrative embodiments, this description is not meant to be construed in a limiting sense. It is understood that although the present invention has been described, various modifications of the illustrative embodiments, as well as additional embodiments of the invention, will be apparent to one of ordinary skill in the art upon reference to this description without departing from the spirit of the invention, as recited in the claims appended hereto. Consequently, the method, system and portions thereof and of the described method and system may be implemented in different locations, such as network elements, the wireless unit, the base station, a base station controller, a mobile switching center and/or a radar system. Moreover, processing circuitry required to implement and use the described system may be implemented in application specific integrated circuits, software-driven processing circuitry, firmware, programmable logic devices, hardware, discrete components or arrangements of the above components as would be understood by one of ordinary skill in the art with the benefit of this disclosure. Those skilled in the art will readily recognize that these and various other modifications, arrangements and methods can be made to the present invention without strictly following the exemplary applications illustrated and described herein and without departing from the spirit and scope of the present invention. It is therefore contemplated that the appended claims will cover any such modifications or embodiments falling within the true scope of the invention.

1. A method of communicating messages between a transmitter and receiver comprising:
sending a message in sequence and having a sequence number;
incrementing an expected sequence number stored in the receiver upon receipt of the message; and
comparing the received sequence number in the message decoded to the incremented expected sequence number and if further decoding if the numbers match.

2. A method according to claim 1, wherein upon receipt of a message, the expected sequence number is incremented by plus one.

3. A method according to claim 1, wherein after reaching a maximum value upon a further increment the stored sequence number, the stored sequence number reverts to or through zero and a stored secondary count is incremented.

4. A method according to claim 3, wherein the stored sequence number is 4 bits, increments are by plus one, the next incremented sequence number after a 1111 value is a 0000 value, and the stored secondary count is up to 28 bits.

5. A method according to claim 1, wherein a value is determined of a COUNT-I parameter depending on the incremented stored sequence number if the numbers match, and the COUNT-I parameter value employed in a f9 integrity checking method.

6. A method according to claim 5, wherein the COUNT-I parameter value depends on the incremented stored sequence number and the secondary count.

7. A method of receiving messages at a receiver, each message having a sequence number, the method comprising:
incrementing an expected sequence number stored in the receiver upon receipt of a message;
decoding the received sequence number in the message; and
comparing the decoded received sequence number in the message with the incremented expected sequence number and further decoding if the numbers match.

8. A communication system operative with a plurality of user terminals, the communication system comprising:
a base station operative to send at least one of a plurality of messages to at least one user terminal in sequence, each message having a sequence number, an expected sequence number stored in the user terminal being incremented upon receipt of a message such that the received sequence number in the message is decoded, compared to the incremented expected sequence number and further decoded if the numbers match.

9. A communication system comprising:
a receiver operative to receive messages each including a sequence number, the receiver including a data store for storing an expected sequence number, the stored expected sequence number being incremented upon receipt of a message, the receiver comprising:
a decoder being operative to decode a received sequence number in the message; and
a comparator being operative to compare the received sequence number to the stored incremented expected sequence number and to further decode if the numbers match.

10. A communication system according to claim 9, wherein the receiver is a user terminal.
